(19) United States
(12) Patent Application Publication
(10) Pub. No.: US 2017/0166061 A1
(43) Pub. Date: Jun. 15, 2017

(54) MOTOR ASSEMBLY

(71) Applicants: TOYOTA JIDOSHA KABUSHIKI KAISHA, Toyota-shi (JP); Alchemica Corporation, Susono-shi (JP)

(72) Inventors: Hiroshi ISONO, Susono-shi (JP); Nobuyoshi SUGITANI, Susono-shi (JP); Aizoh KUBO, Kyoto-shi (JP)

(73) Assignees: TOYOTA JIDOSHA KABUSHIKI KAISHA, Toyota-shi (JP); Alchemica Corporation, Susono-shi (JP)

(21) Appl. No.: 15/377,335

(22) Filed: Dec. 13, 2016

(30) Foreign Application Priority Data
Dec. 15, 2015 (JP) 2015-243941

(51) Int. Cl. B60L 7/24; H02K 7/00; F16D 65/18; B60T 13/74; F16D 55/02; H02K 7/106; B60L 11/18

(52) U.S. Cl. CPC B60L 7/24; H02K 7/106; H02K 7/006; B60L 11/18; B60T 13/748; F16D 55/02; F16D 65/18; F16D 2121/20

(57) ABSTRACT

A motor having an electromagnetic brake is provided to ensure a braking torque even when power is off. The motor assembly comprises a drive motor and an electromagnetic brake. A thrust generating mechanism translates rotational motion of a brake motor to linear motion to generate thrust force for moving any one of brake stator and brake rotor of the electromagnetic brake thereby maintaining frictional contact therebetween to stop rotation of a motor shaft.

### CROSS REFERENCE TO RELATED APPLICATION

The present invention claims the benefit of Japanese Patent Application No. 2015-243941 filed on Dec. 15, 2015 with the Japanese Patent Office, the disclosures of which are incorporated herein by reference in its entirety.

### BACKGROUND

Field of the Invention

Embodiments of the present application relates to the art of a motor used as a prime mover of automobiles, and especially to a motor having an electromagnetic brake for halting a motor shaft when energized.

Discussion of the Related Art

JP-A-2008-236996 describes a motor provided with an electromagnetic brake. According to the teaching of JP-A-2008-236996, a brake rotor of the electromagnetic brake is fixed to one end of a motor shaft (i.e., an output shaft of the motor). Specifically, the electromagnetic brake taught by JP-A-2008-236996 comprises: the brake rotor including a disc part to which a friction plate is attached and a cylinder part fixed to the motor shaft; an armature that is contacted with and separated from the friction plate; a spring for pushing the armature toward the friction plate; and an electromagnet that attracts the armature by an attracting force larger than the pushing force of the spring. The brake rotor is brought into engagement with the brake stator by energizing the electromagnet to halt the motor shaft.

In vehicles using the above-explained motor having an electromagnetic brake as a prime mover, an inboard brake may be used to stop the rotation of drive wheels instead of a conventional brake. In this case, an unsprung load of the vehicle may be reduced, and additional design freedom may be obtained.

However, the electromagnetic brake will not establish a braking torque until a magnetizing coil is energized. That is, a braking torque to stop a motion of a vehicle cannot be maintained during parking while turning the power off.

In the electromagnetic brake, a spring that can establish a braking torque elastically without being energized may also be used instead of the magnetizing coil. In this case, however, a braking torque is generated immediately when turn off power to stop the rotation of a driveshaft of the vehicle connected to the motor shaft. For example, if the power is disconnected during propulsion due to failure, the vehicle would be stopped suddenly. For this reason, the motor having the electromagnetic brake of this kind is not suitable to be used as a prime mover of automobiles.

### SUMMARY

Aspects of embodiments of the present application have been conceived noting the foregoing technical problems, and it is therefore an object of embodiments of the present invention is to provide a motor having an electromagnetic brake that can establish a braking torque even when power is off.

The present application relates to a motor assembly, comprising: a drive motor having a stator that is fixed to a casing, a rotor that is allowed to rotate relatively to the stator, and a motor shaft that is supported by the casing while being allowed to rotate integrally with the rotor; and an electromagnetic brake having a brake rotor that is rotated integrally with the motor shaft, a brake stator that is restricted to rotate around the motor shaft, and a brake solenoid that is energized to magnetically provide a frictional contact between the brake stator and the brake rotor to stop rotation of the motor shaft. In order to achieve the above-explained objective, according to the preferred embodiment of the present application, the motor assembly is provided with a thrust generating mechanism that translates rotational motion to linear motion to generate thrust force for moving any one of the brake stator and the brake rotor thereby maintaining the frictional contact therebetween to stop the rotation of the motor shaft; and a brake motor that applies torque to the thrust generating mechanism to generate the thrust force for moving any one of the brake stator and the brake rotor.

In a non-limiting embodiment, the thrust generating mechanism may include a feed screw mechanism that is adapted to generate the thrust force for providing the frictional contact between the brake stator and the brake rotor when rotated in a predetermined direction, and to cancel the thrust force when rotated in the counter direction.

In a non-limiting embodiment, the brake rotor, the brake stator, the drive motor, the brake motor and the thrust generating mechanism may be arranged coaxially in order from a protruding end of the motor shaft. In this case, the motor assembly may be further provided with a push rod that is supported by the casing while being allowed to move in the axial direction to connect the brake stator and the thrust generating mechanism, and the thrust force of the thrust generating mechanism may be applied to the brake stator through the push rod.

In a non-limiting embodiment, the drive motor, the brake rotor, the brake stator, the thrust generating mechanism and the brake motor may be arranged coaxially in order from a protruding end of the motor shaft. In this case, the thrust force of the thrust generating mechanism may be applied directly to the brake stator.

Thus, according to the embodiment of the present application, the drive motor is provided with the electromagnetic brake for stopping the rotation of the motor shaft. That is, the motor assembly according to the embodiment may be used not only as a prime mover of an automobile but also as an inboard brake. As described, the motor assembly comprises the thrust generating mechanism and the brake motor. According to the embodiment, therefore, the frictional engagement of the brake stator and the brake rotor may be maintained by the thrust force of the thrust generating mechanism even when the electromagnetic brake is unenergized and hence braking torque is not established by the electromagnetic brake. In other words, the motor assembly according to the embodiment may serve as a parking brake to maintain the braking torque when power is off.

Specifically, a reversed efficiency of the feed screw mechanism to translate linear motion to rotational motion is adjusted to be lower than forward efficiency to translate rotational motion to linear motion. According to the embodiment, therefore, the motor shaft may be halted by the feed screw mechanism even after stopping current supply to the brake solenoid and the brake motor.

In the case of arranging the brake rotor, the brake stator, the drive motor, the brake motor and the thrust generating mechanism in order from the protruding end of the motor shaft, those members may be compactly arranged on the common axis to achieve a motor function and a brake function. Consequently, the vehicle using the motor assembly may be downsized and lightened. In addition, the push rod may serve not only as a torque receiving mechanism for restricting the rotation of the brake stator but also as a guide mechanism to reciprocate the brake stator in the axial direction. According to the embodiment, therefore, number of parts of the motor assembly may be reduced to save a manufacturing cost.

In the case of arranging the drive motor, the brake rotor, the brake stator, the thrust generating mechanism and the brake motor in order from the protruding end of the motor shaft, those members may be compactly arranged on the common axis to achieve a motor function and a brake function. In this case, the vehicle using the motor assembly may be downsized and lightened. In addition, since the thrust force of the thrust generating mechanism is applied directly to the brake stator, a structure of the motor assembly may be simplified.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1 is a cross-sectional view showing a first example of the motor assembly according to the embodiment;

FIG. 2 is a cross-sectional view showing a second example of the motor assembly according to the embodiment;

FIG. 3 is a cross-sectional view showing a third example of the motor assembly according to the embodiment; and

FIG. 4 is a perspective view showing a structure of a rack and pinion mechanism used as the thrust generating mechanism.

### DETAILED DESCRIPTION OF THE PREFERRED EMBODIMENT(S)

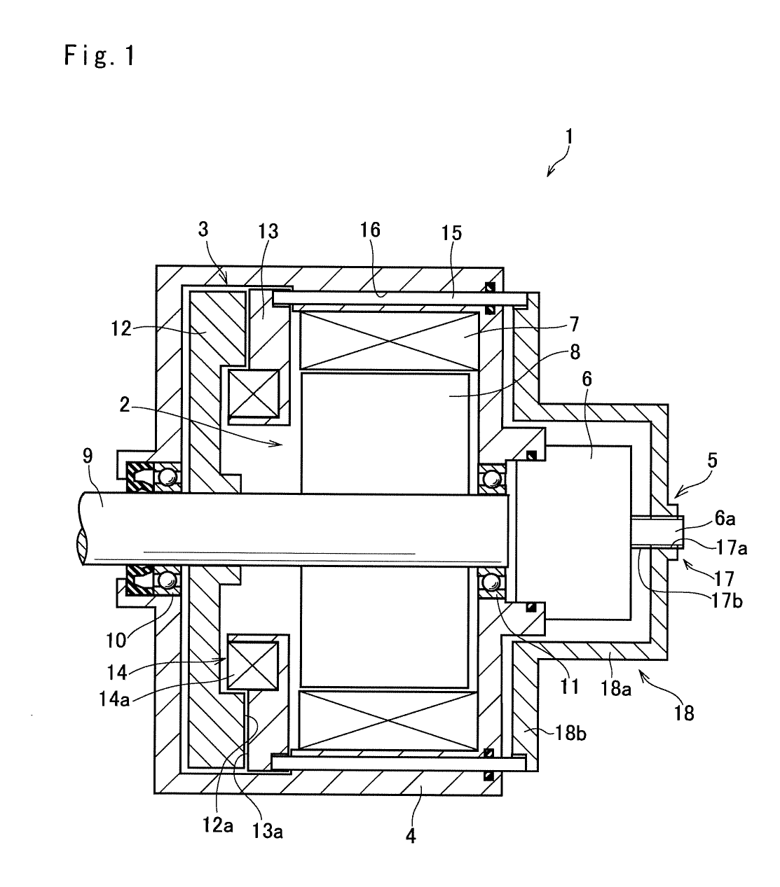

Preferred embodiments of the present application will now be explained with reference to the accompanying drawings. Referring now to FIG. 1, there is shown a first example of a motor having an electromagnetic brake. As illustrated in FIG. 1, a motor assembly 1 comprises a drive motor 2, an electromagnetic brake 3, a casing 4 holding the drive motor 2 and the electromagnetic brake 3 therein, a thrust generating mechanism 5 and a brake motor 6.

The drive motor 2 is intended to be used as a prime mover of a vehicle, and for example, a permanent magnet synchronous motor, and an induction motor may be used as the drive motor 2. Specifically, the drive motor 2 comprises a stator 7 that is fixed to an inner face of the casing 4, a motor shaft 9 as an output shaft of the drive motor 2 that is supported by bearings 10 and 11 in a rotatable manner at both ends of the casing 4, and a rotor 8 fitted onto the rotor shaft 9 to be rotated integrally with the rotor shaft 9 but relatively to the stator 7. One of end portions of the motor shaft 9 (of the left side in FIG. 1) protrudes from the casing 4, and the other end portion of the motor shaft 9 (of the right side in FIG. 1) is held in the casing 4.

The electromagnetic brake 3 comprises a brake rotor 12, a brake stator 13, and a brake solenoid 14. When the brake solenoid 14 is energized, the brake stator 13 is brought into contact to the brake rotor 12 to generate braking torque for stopping the rotation of the motor shaft 9. That is, the electromagnetic brake 3 will not generate braking torque unless the brake solenoid 14 is energized.

Specifically, the brake rotor 12 is a disc-shaped magnetic member, and the brake rotor 12 is also fitted onto the motor shaft 9 to be rotated integrally with the motor shaft 9. A first friction face 12a is formed on an outer circumferential portion of one face the brake rotor 12 to be opposed to a below-mentioned second friction face 13a of the brake stator 13.

The brake stator 13 is an annular magnetic member, and the brake stator 13 is supported by at least two push rods 15 individually as a rod member or a pipe member at an outer circumferential portion of a face opposite to the second friction face 13a. Specifically, each of the push rod 15 is individually inserted into through holes 16 penetrating through the casing 4 in an axial direction, and one end of each of the push rod 15 is individually fitted into insertion holes or notches formed on the outer circumferential portion of the opposite face of the brake stator 13 to the second friction face 13a. The push rods 15 may be fitted loosely into the insertion holes of the brake stator 13, and in this case, the push rods 15 are fitted into the insertion holes sufficiently deeply so as to prevent disengagement when a thrust force pushing the brake stator 13 is cancelled.

Thus, in the casing 4, the brake stator 13 is supported by the rod members 15 while being allowed to reciprocate in the axial direction but restricted to rotate around the motor shaft 9. That is, the push rods 15 serve as a torque receiving mechanism for restricting the rotation of the brake stator 13.

Alternatively, the push rods 15 may be fitted tightly into the insertion holes of the brake stator 13, or fixed to each other by a bolt, an adhesive agent or a welding. In this case, the push rods 15 are reciprocated in the through holes 16 integrally with the brake stator 13. That is, the rods 15 may also serve as a guide mechanism to reciprocate the brake stator 13 in the axial direction.

The above-mentioned second friction face 13a is formed on the outer circumferential portion of the face of the brake stator 13 opposed to the first friction face 12a of the brake rotor 12.

The brake solenoid 14 comprises the brake rotor 12 serving as a fixed magnetic pole, a coil 14a wound around an iron core (not shown), and the brake stator 13 serving as a movable magnetic pole. The coil 14a is attached to the brake stator 13 so that the coil 14a is reciprocated together with the brake stator 13. Specifically, when a predetermined current is applied to the coil 14a, the coil 14a establishes magnetic attraction to be pulled toward the brake rotor 12 together with the brake stator 13. Consequently, the second friction face 13a of the brake stator 13 is frictionally engaged with the first friction face 12a of the brake rotor 12 to stop the rotation of the motor shaft 9. Optionally, although not especially illustrated in FIG. 1, a return spring may be used to isolate the second friction face 13a away from the first friction face 12a when stopping current supply to the coil 14a to allow the motor shaft 9 to rotate.

The motor assembly 1 is adapted to maintain the frictional engagement of the first friction face 12a and the second friction face 13a thereby stopping the rotation of the motor shaft 9 even when the coil 14a is unenergized. To this end, the motor assembly 1 is provided with the thrust generating mechanism 5 and the brake motor 6.

Specifically, the thrust generating mechanism 5 is adapted to convert rotary motion into linear motion to generate thrust force for pushing the brake stator 13 toward the brake rotor 12 to keep stopping the rotation of the motor shaft 9. According to the first example shown in FIG. 1, a feed screw mechanism 17 is used in the thrust generating mechanism 5.

According to the first example shown in FIG. 1, specifically, the thrust generating mechanism 5 comprises the feed screw mechanism 17, and a pushing member 18 including a cover member 18a covering the brake motor 6 and a flange member 18b expanding radially outwardly from an opening of the cover member 18a. A female thread hole 17a is formed on a center of a bottom of the cover member 18a, and the brake motor 6 is held in the cover member 18a while being fixed to the drive motor 2. The other end of each of the push rod 15 is individually fitted into insertion holes or notches formed on an outer circumferential portion of a face of the flange member 18b being opposed to the casing 4. The other ends of the push rods 15 may also be fitted loosely into the insertion holes of the flange member 18b, and in this case, the push rods 15 are fitted into the insertion holes sufficiently deeply so as to prevent disengagement when the thrust force pushing the brake stator 13 through the push rods 15 is cancelled.

A male thread 17b is formed on an outer circumferential surface of an output shaft 6a of the brake motor 6, and the male thread 17 is screwed into the female thread hole 17a of the cover member 18a.

For example, a ball screw actuator, a trapezoidal screw actuator, a square screw actuator etc. may serve as the female thread hole 17a and the male thread 17b. Specifically, the feed screw mechanism 17 generates a thrust force (or an axial force) for pushing the pushing member 18 in the axial direction toward the drive motor 2 by rotating the output shaft 6a of the brake motor 6 on which the male thread 17b is formed in a predetermined direction (i.e., in the forward direction). By contrast, the pushing member 18 is withdrawn from the drive motor 2 by rotating the output shaft 6a of the brake motor 6 in the opposite direction (i.e., in the reverse direction).

Thus, in the thrust generating mechanism 5, the feed screw mechanism 17 generates forward thrust force by generating forward torque by the brake motor 6, and the forward thrust force is applied to the brake stator 13 through the pushing member 18 and the push rods 15. Consequently, the brake stator 13 is pushed toward the brake rotor 12 so that the second friction face 13a of the brake stator 13 is frictionally engaged with the first friction face 12a of the brake rotor 12 to stop the rotation of the motor shaft 9. By contrast, the motor shaft 9 is allowed to rotate by generating a reverse torque by the brake motor 6 to withdraw the second friction face 13a of the brake stator 13 from the first friction face 12a of the brake rotor 12. That is, the braking force for stopping the rotation of the motor shaft 9 is cancelled.

In addition, reversed efficiency of the feed screw mechanism 17 to translate linear motion to rotational motion is adjusted to be lower than forward efficiency to translate rotational motion to linear motion. That is, mechanical efficiency of the feed screw mechanism 17 is tuned in such a manner that the pushing member 18 is moved more efficiently toward the brake rotor 12 by rotating the male thread 17b in the forward direction, and that the male thread 17b is rotated in the reverse direction less efficiently by withdrawing the pushing member 18 from the brake rotor 12. According to the first example, therefore, the motor shaft 9 may be halted easily by pushing the brake stator 13 toward the brake rotor 12 by the feed screw mechanism 17 even when the coil 14a of the brake solenoid 14 and the brake motor 6 are unenergized.

According to the first example shown in FIG. 1, the brake rotor 12, the brake stator 13, the drive motor 2, the brake motor 6 and the thrust generating mechanism 5 are arranged coaxially in order from a protruding end of the motor shaft 9. In the motor assembly 1 thus structured, each of the push rod 15 connecting the brake stator 13 and the flange member 18b across the drive motor 2 is individually inserted into the through hole 16 formed in the casing 4. According to the first example, therefore, the above-mentioned members may be compactly arranged on the common axis to achieve a motor function and a brake function. Consequently, the vehicle using the motor assembly 1 may be downsized and lightened.

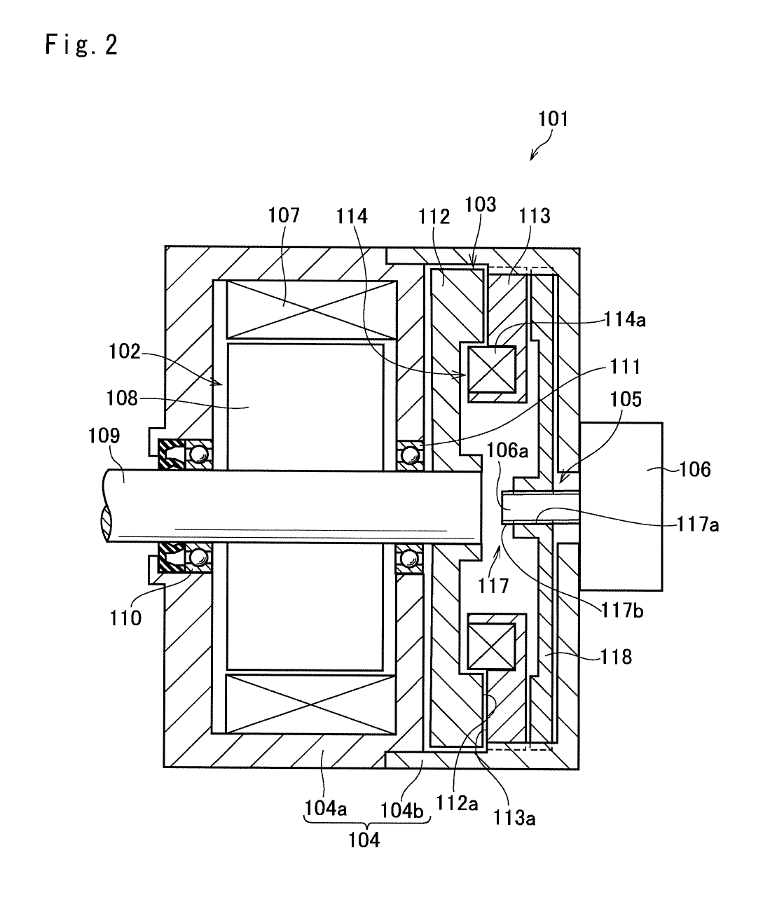

Turning to FIG. 2, there is shown a second example of the motor having an electromagnetic brake according to the present application. As illustrated in FIG. 2, a motor assembly 101 comprises a drive motor 102, an electromagnetic brake 103, a casing 104 holding the drive motor 102 and the electromagnetic brake 103 therein, a thrust generating mechanism 105 and a brake motor 106. According to the second example, the casing 104 is divided into a motor case 104a and a brake case 104b, and an opening end of the brake case 104b is attached to one of axial ends of the motor case 104a.

As the drive motor 2 of the first example, a permanent magnet synchronous motor and an induction motor may also be used as the drive motor 102. Specifically, the drive motor 102 comprises a stator 107 that is fixed to an inner face of the motor case 104a, a motor shaft 109 as an output shaft of the drive motor 102 that is supported by bearings 110 and 111 in a rotatable manner at both ends of the motor case 104a, and a rotor 108 fitted onto the rotor shaft 109 to be rotated integrally with the rotor shaft 109 but relatively to the stator 107. Thus, according to the second example, the stator 107 and the rotor 108 are held in the motor case 104a. One of end portions of the motor shaft 109 (of the left side in FIG. 2) protrudes from one side of the motor case 104a, and the other end portion of the motor shaft 109 (of the right side in FIG. 1) protrudes from the other side of the motor case 104a but still held in the brake case 104b.

The electromagnetic brake 103 comprises a brake rotor 112, a brake stator 113, and a brake solenoid 114. When the brake solenoid 114 is energized, the brake stator 113 is brought into contact to the brake rotor 112 to generate braking torque for stopping the rotation of the motor shaft 109. That is, the electromagnetic brake 103 will not generate braking torque unless the brake solenoid 114 is energized.

The brake rotor 112 is also a disc-shaped magnetic member, and the brake rotor 112 is fitted onto the motor shaft 109 to be rotated integrally therewith in the brake case 104b. A first friction face 112a is formed on an outer circumferential portion of one face the brake rotor 112 to be opposed to a below-mentioned second friction face 113a of the brake stator 13.

The brake stator 113 is also an annular magnetic member, and the brake stator 113 is splined to an inner circumferential face of the brake case 104b. Specifically, a spline ridge is formed on an outer circumferential face of the brake stator 113 in the axial direction, and the spline ridge of the brake stator 113 is fitted into a spline groove formed on the inner circumferential face of the brake case 104b in the axial direction. Thus, in the brake case 104b, the brake stator 113 is allowed to reciprocate in the axial direction but restricted to rotate around the motor shaft 109. The above-mentioned second friction face 113a is formed on the outer circumferential portion of the face of the brake stator 113 opposed to the first friction face 12a of the brake rotor 112. A pushing plate 118 of the thrust generating mechanism 105 is interposed between the bottom face of the brake case 104b and the brake stator 113.

The brake solenoid 114 comprises the brake rotor 112 serving as a fixed magnetic pole, a coil 114a wound around an iron core (not shown), and the brake stator 113 serving as a movable magnetic pole. The coil 114a is attached to the brake stator 113 so that the coil 114a is reciprocated together with the brake stator 113. Specifically, when a predetermined current is applied to the coil 114a, the coil 114a establishes magnetic attraction to be pulled toward the brake rotor 112 together with the brake stator 113. Consequently, the second friction face 113a of the brake stator 113 is frictionally engaged with the first friction face 112a of the brake rotor 112 to stop the rotation of the motor shaft 109. Optionally, although not especially illustrated in FIG. 2, a return spring may be used to isolate the second friction face 113a away from the first friction face 112a when stopping current supply to the coil 114a to allow the motor shaft 9 to rotate.

The motor assembly 101 is adapted to maintain the frictional engagement of the first friction face 112a and the second friction face 113a thereby stopping the rotation of the motor shaft 109 even when the coil 114a is unenergized. To this end, the motor assembly 101 is also provided with the thrust generating mechanism 105 and the brake motor 106.

The thrust generating mechanism 105 is also adapted to convert rotary motion into linear motion to generate thrust force for pushing the brake stator 113 toward the brake rotor 112 to keep stopping the rotation of the motor shaft 9. In the second example shown in FIG. 2, a feed screw mechanism 117 is also used in the thrust generating mechanism 105.

According to the second example shown in FIG. 2, specifically, the thrust generating mechanism 5 comprises the feed screw mechanism 117, and the disc-shaped pushing plate 118. Specifically, a spline ridge is formed on an outer circumferential face of the pushing plate 118 in the axial direction, and the spline ridge of the pushing plate 118 is fitted into the spline groove formed on the inner circumferential face of the brake case 104b in the axial direction. Thus, in the brake case 104b, the pushing plate 118 is also allowed to reciprocate in the axial direction but restricted to rotate around the motor shaft 109.

A female thread hole 117a is formed on a center of the pushing plate 118, and the brake motor 106 is attached to an outer face of the brake case 104b coaxially with the motor shaft 109.

A male thread 117b is formed on an outer circumferential surface of an output shaft 106a of the brake motor 106, and the male thread 17 is screwed into the female thread hole 117a of the pushing plate 118 toward the brake rotor 112.

Specifically, the feed screw mechanism 117 generates a thrust force (or an axial force) for pushing the pushing member 118 in the axial direction toward the drive motor 102 by rotating the output shaft 106a of the brake motor 106 on which the male thread 117b is formed in the forward direction. By contrast, the pushing plate 118 is withdrawn from the drive motor 102 by rotating the output shaft 106a of the brake motor 106 in the reverse direction.

Thus, in the thrust generating mechanism 105, the feed screw mechanism 117 generates forward thrust force by generating forward torque by the brake motor 106, and the forward thrust force is applied to the brake stator 113 through the pushing plate 118. Consequently, the brake stator 113 is pushed toward the brake rotor 112 so that the second friction face 113a of the brake stator 113 is frictionally engaged with the first friction face 112a of the brake rotor 112 to stop the rotation of the motor shaft 109. By contrast, the motor shaft 109 is allowed to rotate by generating a reverse torque by the brake motor 106 to withdraw the pushing plate 118 so that the second friction face 113a of the brake stator 113 is disengaged from the first friction face 112a of the brake rotor 112. That is, the braking force for stopping the rotation of the motor shaft 9 is cancelled.

In addition, reversed efficiency of the feed screw mechanism 117 to translate linear motion to rotational motion is also adjusted to be lower than forward efficiency to translate rotational motion to linear motion. According to the second example, therefore, the motor shaft 109 may also be halted easily by pushing the brake stator 113 toward the brake rotor 112 by the feed screw mechanism 117 even when the coil 114a of the brake solenoid 114 and the brake motor 106 are unenergized.

According to the second example shown in FIG. 2, the drive motor 102, the brake rotor 112, the brake stator 113, the thrust generating mechanism 105 and the brake motor 106 are arranged coaxially in order from a protruding end of the motor shaft 109. According to the first example, therefore, the above-mentioned members may be compactly arranged on the common axis to achieve a motor function and a brake function. Consequently, the vehicle using the motor assembly 101 may be downsized and lightened. In addition, since the above-mentioned push rods 15 are not used in the motor assembly 101, structure of the motor assembly 101 may be simplified.

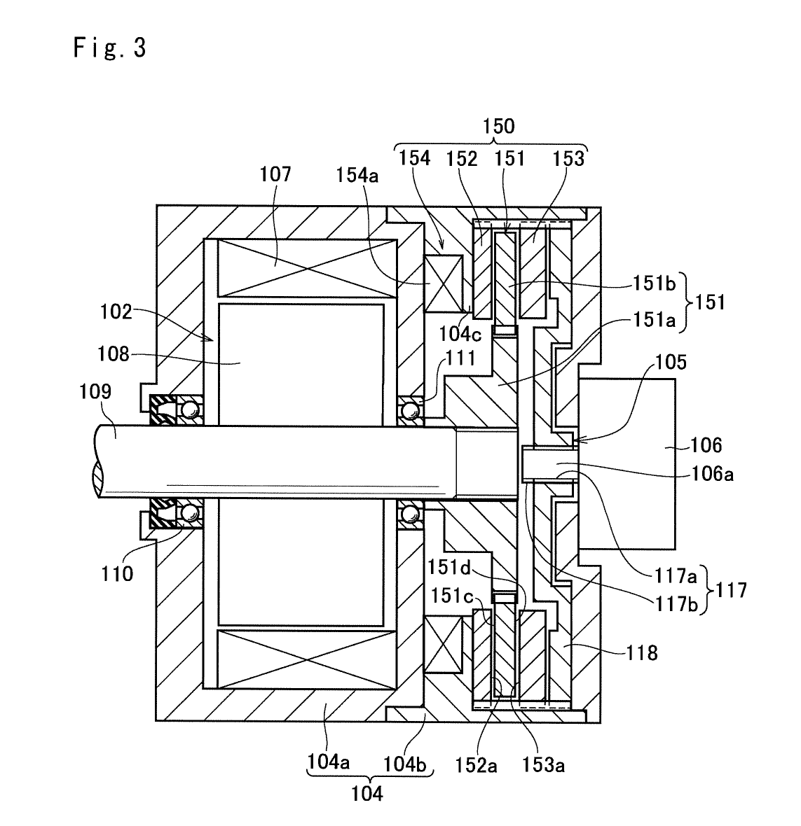

In addition to the foregoing examples, according to the present application, the brake rotor may also be moved toward the brake stator to be engaged therewith, and both of the brake rotor and the brake stator may also be moved toward each other to be engaged. Turning to FIG. 3, there is shown a third example of the motor having an electromagnetic brake in which a brake rotor and brake stators are moved to stop the rotation of the motor shaft. According to the third example, the electromagnetic brake 150 comprises a brake rotor 151, a first brake stator 152, a second brake stator 153, and a brake solenoid 154. When the brake solenoid 154 is energized, the first brake stator 152, the brake rotor 151 and the second brake stator 153 are brought into contact to one another to generate braking torque for stopping the rotation of the motor shaft 109. That is, the electromagnetic brake 150 will not generate braking torque unless the brake solenoid 154 is energized.

The brake rotor 151 comprises a boss portion 151a fitted onto the motor shaft 109 to be rotated integrally therewith, and an engagement portion 151b as an annular magnetic member. A spline ridge is formed on an outer circumferential surface of the boss portion 151a in the axial direction, and the spline ridge of the boss portion 151a is fitted into a spline groove formed on an inner circumferential face of the engagement portion 151b in the axial direction. That is, the engagement portion 151b is rotated integrally with the motor shaft 109 and the boss portion 151b, and allowed to move in the axial direction relatively to the motor shaft 109 and the boss portion 151b.

The first brake stator 152 and the second brake stator 153 are arranged coaxially across the engagement portion 151b of the brake rotor 151. A first friction face 151c is formed on one face the engagement portion 151b to be opposed to a second friction face 152a of the first brake stator 152. Likewise, a third friction face 151d is formed on the other face the engagement portion 151b to be opposed to a fourth friction face 153a of the second brake stator 153.

The first brake stator 152 is also an annular magnetic member, and the first brake stator 152 is splined to an inner circumferential face of the brake case 104b. Specifically, a spline ridge is formed on an outer circumferential face of the first brake stator 152 in the axial direction, and the spline ridge of the first brake stator 152 is fitted into the spline groove formed on the inner circumferential face of the brake case 104b in the axial direction. Thus, in the brake case 104b, the first brake stator 152 is allowed to reciprocate in the axial direction but restricted to rotate around the motor shaft 109. The above-mentioned second friction face 152a is formed on one face of the first brake stator 152 opposed to the first friction face 151c of the engagement portion 151b of the brake rotor 151. The other face of the first brake stator 152 is opposed to an inner rim 104c of the brake case 104b to which the brake solenoid 154 is attached from the other side. According to the third example, at least the inner rim inner rim 104c is formed of magnetic body in the brake case 104b.

The second brake stator 153 is also an annular magnetic member, and the second brake stator 153 is also splined to the inner circumferential face of the brake case 104b. Specifically, a spline ridge is also formed on an outer circumferential face of the second brake stator 153 in the axial direction, and the spline ridge of the second brake stator 153 is fitted into the spline groove formed on the inner circumferential face of the brake case 104b in the axial direction. Thus, in the brake case 104b, the second brake stator 153 is also allowed to reciprocate in the axial direction but restricted to rotate around the motor shaft 109. The above-mentioned fourth friction face 153a is formed on one face of the second brake stator 153 opposed to the third friction face 151d of the engagement portion 151b of the brake rotor 151. The other face of the second brake stator 153 is opposed to the pushing plate 118 of the thrust generating mechanism 105.

The brake solenoid 154 comprises the inner rim 104c serving as a fixed magnetic pole, a coil 154a wound around an iron core (not shown), and the brake rotor 151, the first brake stator 152 and the second brake stator 153 individually serving as a movable magnetic pole. The coil 154a is attached to the inner rim 104c of the brake case 104b so that the first brake stator 152, the brake rotor 151 and the second brake stator 153 are magnetically attracted to the inner rim 104c when a predetermined current is applied to the coil 154a. Consequently, the first friction face 151c of the brake rotor 151 is frictionally engaged with the second friction face 152a of the first brake stator 152, and the fourth friction face 153a of the second brake stator 153 is frictionally engaged with the third friction face 151d of the brake rotor 151 to stop the rotation of the motor shaft 109. According to the third example, the motor shaft 109 may also be halted continuously even when the coil 154a of the brake solenoid 154 is unenergized by applying forward thrust force of the thrust generating mechanism 105 to the pushing plate 118 to push the second brake stator 153, the brake rotor 151 and first brake stator 152 toward the drive motor 102.

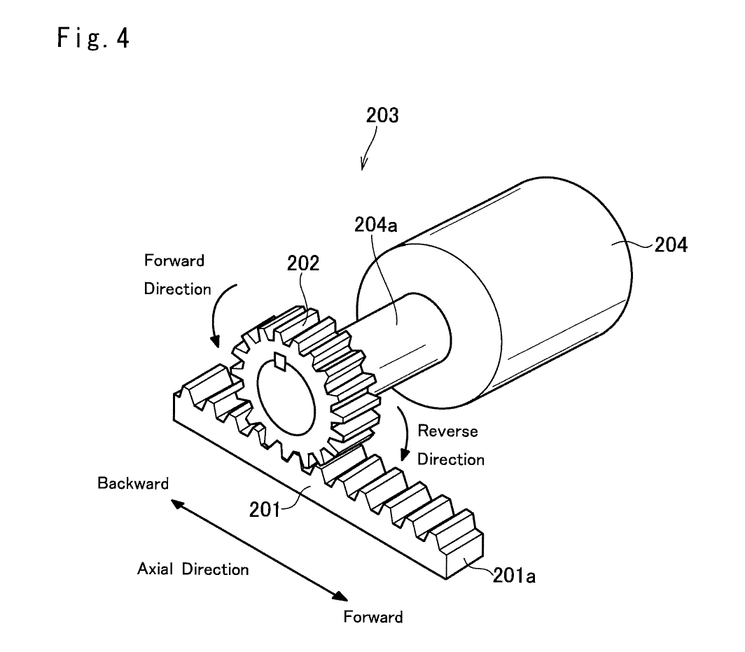

Optionally, in the motor assemblies according to the foregoing examples, a rack-and pinion mechanism may also be employed as the thrust generating mechanism instead of the feed screw mechanism. An example of structure of the rack-and pinion mechanism possible to use in the motor assemblies of the foregoing examples is shown in FIG. 4. The thrust generating mechanism 203 comprises a rack 201 that is allowed to move in the axial direction of the motor shaft 9 or 109, and a pinion 202 that is rotated to move the rack 201 engaged therewith in the axial direction.

One end 201a of the rack 201 may be connected to the push rod 15 or the pushing plate 118. In this case, the push rod 15 or the pushing plate 118 is moved forward by moving the rack 201. Alternatively, said one end 201a of the rack 201 may also be connected directly to the brake stator 13 or 113 to push the brake stator 13 or 113 in the forward direction directly by the rack 201.

The pinion 202 is connected to an output shaft 204a of a brake motor 204 to be rotated integrally therewith while being meshed with the rack 201 so that the rack 201 is reciprocated in the axial direction by rotating the rack 201 by the brake motor 204. In the example shown in FIG. 4, specifically, the rack 201 is moved forward by rotating the pinion 202 in the forward direction, and the rack 201 is moved backwardly by rotating the pinion 202 in the reverse direction. Although not especially illustrated in FIG. 4, the pinion 202 or the output shaft 204a is provided with a backstop device to prevent reverse rotation of the pinion 202 or the output shaft 204a when the rack 201 is moved to the forward-most position to keep engagement of the brake rotor 12 or 112 and the brake stator 13 or 113. To this end, for example, a reversible ratchet and a one-way clutch may be used as the backstop device.

Thus, rotational motion of the brake motor 204 may also be translate into linear motion by the rack 201 and the pinion 202 to push the brake stator 13 or 113 toward the brake rotor 12 or 112 thereby keeping engagement of the brake stator 13 or 113 and the brake rotor 12 or 112 to stop rotation of the motor shaft 9 or 109.

Although the above exemplary embodiment of the present application have been described, it will be understood by those skilled in the art that the present application should not be limited to the described exemplary embodiment, and various changes and modifications can be made within the spirit and scope of the present application.

What is claimed is:

1. A motor assembly, comprising:
a drive motor having a stator that is fixed to a casing, a rotor that is allowed to rotate relatively to the stator, and a motor shaft that is supported by the casing while being allowed to rotate integrally with the rotor;
an electromagnetic brake having a brake rotor that is rotated integrally with the motor shaft, a brake stator that is restricted to rotate around the motor shaft, and a brake solenoid that is energized to magnetically provide a frictional contact between the brake stator and the brake rotor to stop rotation of the motor shaft;
a thrust generating mechanism that translates rotational motion to linear motion to generate thrust force for moving any one of the brake stator and the brake rotor thereby maintaining the frictional contact therebetween to stop the rotation of the motor shaft; and
a brake motor that applies torque to the thrust generating mechanism to generate the thrust force for moving any one of the brake stator and the brake rotor.

2. The motor assembly as claimed in claim 1, wherein the thrust generating mechanism includes a feed screw mechanism that is adapted to generate the thrust force for providing the frictional contact between the brake stator and the brake rotor when rotated in a predetermined direction, and to cancel the thrust force when rotated in the counter direction.

3. The motor assembly as claimed in claim 1,
wherein the brake rotor, the brake stator, the drive motor, the brake motor and the thrust generating mechanism are arranged coaxially in order from a protruding end of the motor shaft,
further comprising a push rod that is supported by the casing while being allowed to move in the axial direction, and that connects the brake stator and the thrust generating mechanism across the drive motor, and
wherein the thrust force of the thrust generating mechanism is applied to the brake stator through the push rod.

4. The motor assembly as claimed in claim 1,
wherein the drive motor, the brake rotor, the brake stator, the thrust generating mechanism and the brake motor are arranged coaxially in order from a protruding end of the motor shaft, and
wherein the thrust force of the thrust generating mechanism is applied directly to the brake stator.

5. The motor assembly as claimed in claim 2,
wherein the brake rotor, the brake stator, the drive motor, the brake motor and the thrust generating mechanism are arranged coaxially in order from a protruding end of the motor shaft,
further comprising a push rod that is supported by the casing while being allowed to move in the axial direction, and that connects the brake stator and the thrust generating mechanism across the drive motor, and
wherein the thrust force of the thrust generating mechanism is applied to the brake stator through the push rod.

6. The motor assembly as claimed in claim 2,
wherein the drive motor, the brake rotor, the brake stator, the thrust generating mechanism and the brake motor are arranged coaxially in order from a protruding end of the motor shaft, and
wherein the thrust force of the thrust generating mechanism is applied directly to the brake stator.
